(19) United States
(12) Patent Application Publication
(10) Pub. No.: US 2004/0072562 A1
(43) Pub. Date: Apr. 15, 2004

(54) Mobile communications system for use with first and second set of user terminals and method for operating same

(75) Inventors: Dean Vanden Heuvel, Chandler, AZ (US); Scott Blanchard, Mesa, AZ (US)

Correspondence Address: Kenneth A. Nelson, Bryan Cave LLP, Suite 2200, Two North Central Avenue, Phoenix, AZ, 85004-4406, US

(73) Assignee: General Dynamics Decision Systems

(21) Appl. No.: 10/272,026

(22) Filed: Oct. 15, 2002

(51) Int. Cl. H04Q 7/20

(52) U.S. Cl. 455/428; 455/427

(57) ABSTRACT

A mobile communications system is disclosed in which at least a first ground station (12) and a second ground station (14) are connected by a backbone link (16) configured to carry backbone traffic. A first satellite (18) is coupled to the first ground station and to a first set of user terminals (22) by a first set of user links (24). A second satellite (20) is coupled to the second ground station and to a second set of user terminals (26) by a second set of user links (28). Both the first set of user links and the second set of user links are configured to carry user traffic. Each of the set of ground stations is configured to reallocate at least one of the user links to accommodate backbone traffic.

### FIELD OF THE INVENTION

This invention relates in general to telephony, and more particularly to a mobile communications system.

### BACKGROUND OF THE INVENTION

Many communications systems serving diverse geographies require both local infrastructure, called a ground station herein, and “long-line” backbone infrastructure. The local infrastructure conventionally implements the “last mile” connectivity, or user links, between the communications users and the system infrastructure. The local infrastructure is generally confined to providing services within a limited geographical region. The backbone infrastructure implements the connectivity between two or more such limited geographical regions, connecting multiple sets of local infrastructure, and enabling communications between users located in different regions.

Particular communications systems, e.g., certain global mobile telephony systems, are supported through a combination of satellite links and backbone (usually terrestrial) connections, with the satellite links most often providing the user links. The backbone connections, on the other hand, link multiple ground stations with each other and with other terrestrial network systems such as the public switched telephone network (PSTN). The backbone links are most often high-rate, broadband links that carry composite traffic to and from many users simultaneously. Failure within a user link will result in loss of communications for one or a few users, while failure in a backbone link can have a much more widespread effect, potentially disabling communications for all users in a given region.

Existing telephony systems include various provisions for routing backbone traffic along dedicated backup or alternate links in the event of congestion or of route or component failure. These provisions include interconnected trunks and switches within certain networks, line-of-sight microwave backups, and fiber backups, among others. The existing provisions, however, merely provide one form or another of a dedicated link across which backbone traffic may be carried. The high cost of such dedicated resources is a significant obstacle affecting their implementation, and there are a great many regions where few if any alternate routing capabilities are in place. Accordingly, a need exists for a way to maintain communications capabilities within a mobile communications system in spite of possible congestion or device failure within primary traffic links.

### BRIEF DESCRIPTION OF THE DRAWINGS

The invention will be better understood from a reading of the following detailed description, taken in conjunction with the accompanying figures in the drawings in which:

FIG. 1 is a representation of a mobile communications system configured according to an embodiment of the present invention;

FIG. 2 is a more detailed view of a portion of the mobile communications system of FIG. 1 according to an embodiment of the present invention;

FIG. 3 is a representation of a mobile communications system configured according to another embodiment of the present invention; and

FIG. 4 is a flow diagram illustrating a method according to an embodiment of the present invention.

For simplicity and clarity of illustration, the drawing figures illustrate the general manner of construction, and descriptions and details of well-known features and techniques are omitted to avoid unnecessarily obscuring the invention. Additionally, elements in the drawing figures are not necessarily drawn to scale. For example, the dimensions of some of the elements in the figures may be exaggerated relative to other elements to help to improve understanding of embodiments of the present invention. Furthermore, the same reference numerals in different figures denote the same elements.

It is to be understood further, that the terms first, second, third, fourth, and the like in the description and in the claims, if any, are used for distinguishing between similar elements and not necessarily for describing a sequential or chronological order. The terms so used are interchangeable under appropriate circumstances such that the embodiments of the invention described herein are, for example, capable of operation in other sequences than illustrated or otherwise described herein. Moreover, the terms left, right, front, back, top, bottom, over, under, and the like in the description and in the claims, if any, are used for descriptive purposes and not necessarily for describing permanent relative positions. It will be understood that the terms so used are interchangeable under appropriate circumstances such that the embodiments of the invention described herein are, for example, capable of operation in other orientations than illustrated or otherwise described herein. The term coupled, as used herein, is defined as directly or indirectly connected in an electrical, wireless, or other manner.

Additionally, the terms “comprise,” “include,” “have,” and any variations thereof, are intended to cover a non-exclusive inclusion, such that a process, method, article, or apparatus that comprises a list of elements does not include only those elements, but may include other elements not expressly listed or inherent to such process, method, article, or apparatus.

### DETAILED DESCRIPTION OF THE DRAWINGS

A particular embodiment of the mobile communications system described herein comprises at least two ground stations connected by a backbone link configured to carry backbone traffic. A first satellite is coupled to a first ground station and to a first set of user terminals by a first set of user links. A second satellite is coupled to the second ground station and to a second set of user terminals by a second set of user links. Cross user links connect the first satellite and the second satellite. The first set of user links, the second set of user links, and the cross user links are configured to carry user traffic. Each of the set of ground stations is configured to reallocate at least one of the user links to accommodate backbone traffic. The mobile communications system is adapted to be compatible with Code-Division Multiple Access (CDMA), wideband Code-Division Multiple Access (WCDMA), Time-Division Multiple Access (TDMA), Global System for Mobile Communications (GSM), General Packet Radio Service (GPRS), and other multiple access and wireless communications methods and standards.

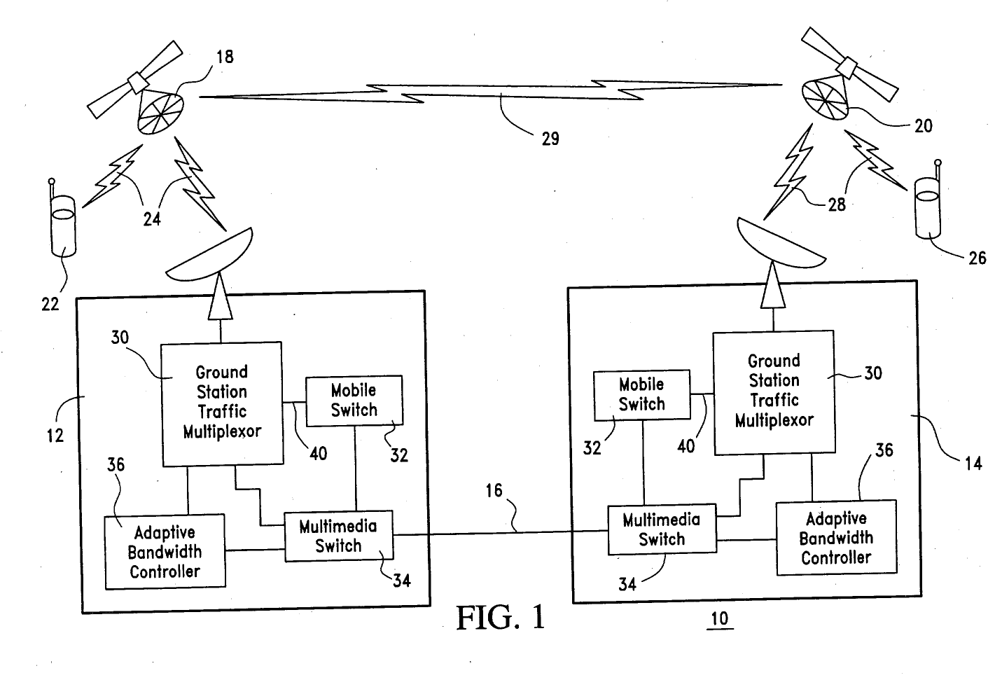

Referring now to the figures, and in particular to FIG. 1, an embodiment of a mobile communications system 10 comprises a set of ground stations, including at least a first ground station 12 and a second ground station 14. First ground station 12 and second ground station 14 are coupled to each other by a backbone link 16 that is configured to carry backbone traffic. As it is used herein, the term “backbone traffic” refers to communications that must pass through more than one ground station on the way to their final destination. Backbone traffic, then, does not comprise those communications that both originate and terminate within the same limited geographical region. Rather, it comprises those communications that travel from one limited geographical region to another. Backbone traffic conventionally comprises, for example, an aggregate of many individual telephone conversations bound for a destination region widely separated from their region of origin. Backbone link 16 may comprise an underground or undersea cable, a dedicated geosynchronous satellite link, a fiber optic cable, a line-of-sight microwave link, or some other link that carries backbone traffic between first ground station 12 and second ground station 14. In one embodiment, backbone link 16 is dedicated exclusively for backbone traffic.

Mobile communications system 10, in one embodiment, further comprises a set of satellites, including at least a first satellite 18 and a second satellite 20. First satellite 18 is coupled to first ground station 12 and to a first set of user terminals 22 by a first set of user links 24. Second satellite 20 is coupled to second ground station 14 and to a second set of user terminals 26 by a second set of user links 28. User terminals, including first set of user terminals 22 and second set of user terminals 26, may for example comprise wireless or cellular telephones, and may also comprise other wireless and hard wire communications devices. First satellite 18 and second satellite 20 are coupled together by one or more cross user links 29. First set of user links 24, second set of user links 28, and cross user links 29 are configured to carry user traffic. The term “user traffic,” as it is used herein, refers to communications that travel from their source to their destination without passing through more than one ground station. First set of user links 24, therefore, link user terminals 22 to each other while passing only through first ground station 12 en route from the originating to the receiving user terminal. User traffic becomes backbone traffic, as both have been defined herein, when it is routed from a first ground station to a second ground station instead of to a user terminal local to the first ground station.

Each one of the set of ground stations, including first ground station 12 and second ground station 14, is configured to at least temporarily reallocate at least one user link to accommodate backbone traffic rather than the user traffic it typically carries. This may be important where, for example, a backbone link experiences congestion or failure. In at least one embodiment, the one or more user links configured to accommodate backbone traffic comprise at least a portion of the radio frequency spectrum that is normally allocated to carry user traffic. Having the ability to dynamically reroute backbone traffic to the best available resource, by reallocating existing user links to accommodate backbone traffic, at least partially reduces the need to build costly redundant resources dedicated to backbone traffic. The rerouting capability may also save costs by allowing the redundant use of ground station components such that if a component in one ground station fails, the corresponding component in another ground station may be used in its place even when the backbone link is gone, thus reducing the need to build as much redundancy into each ground station.

According to an embodiment of the present invention, in those instances where the backbone link is unable to handle the full volume of backbone traffic it is called upon to carry, the ground stations reallocate some or all of that portion of the radio frequency spectrum normally dedicated to user traffic to accommodate, instead, backbone traffic diverted from the compromised backbone link. This reallocation relieves, at least in part, the congestion caused by the backbone link's inability to handle the total backbone traffic, and may help preserve system availability at reduced cost. During operation of mobile communications system 10, the amount of reallocation may vary.

In many instances, backbone link 16 varies in its capacity to handle the total volume of backbone traffic, whether because that total volume is itself constantly fluctuating, because of periodic and random equipment failures, or because of other foreseeable and unforeseeable factors. In order to optimize the performance of mobile communications system 10 in spite of such variances, first ground station 12 and second ground station 14 are configured to dynamically reallocate at least one user link in response to changing conditions experienced by mobile communications system 10. More specifically, first ground station 12 and second ground station 14 are configured to reallocate at least a portion of the radio frequency spectrum normally dedicated to user traffic to accommodate, instead, backbone traffic when congestion or failure of backbone link 16 makes the reallocation necessary, and to return all backbone traffic to backbone link 16 when the congestion or failure is resolved. This dynamic reallocation helps reduce the possibility of widespread outages within mobile communications system 10.

Referring still to FIG. 1, first ground station 12 and second ground station 14 each comprise, in one embodiment, a ground station traffic multiplexor 30, a mobile switch 32, a multimedia switch 34, and an adaptive bandwidth controller 36. Ground station traffic multiplexor 30, mobile switch 32, multimedia switch 34, and adaptive bandwidth controller 36 are coupled together as shown in FIG. 1. More specifically, mobile switch 32 is coupled to ground station traffic multiplexor 30, multimedia switch 34 is coupled to mobile switch 32 and to ground station traffic multiplexor 30, and adaptive bandwidth controller 36 is coupled to multimedia switch 34 and to ground station traffic multiplexor 30.

The other ground stations in the set of ground stations, if any (not shown in FIG. 1), will be, in at least one embodiment, substantially similar to first ground station 12 or second ground station 14 as illustrated in FIG. 1. One of ordinary skill in the art will recognize that the various components of first ground station 12 and second ground station 14, including those discussed above, need not necessarily be embodied as separate devices, as they are depicted in FIG. 1. Rather, the functions performed by two or more of ground station traffic multiplexor 30, mobile switch 32, multimedia switch 34, and adaptive bandwidth controller 36, as well as other components, may be combined in a single device. Multimedia switch 34 could in one embodiment comprise an Asynchronous Transfer Mode (ATM) switch, though that does not necessarily imply that other components of mobile communications system 10 must operate on ATM facilities.

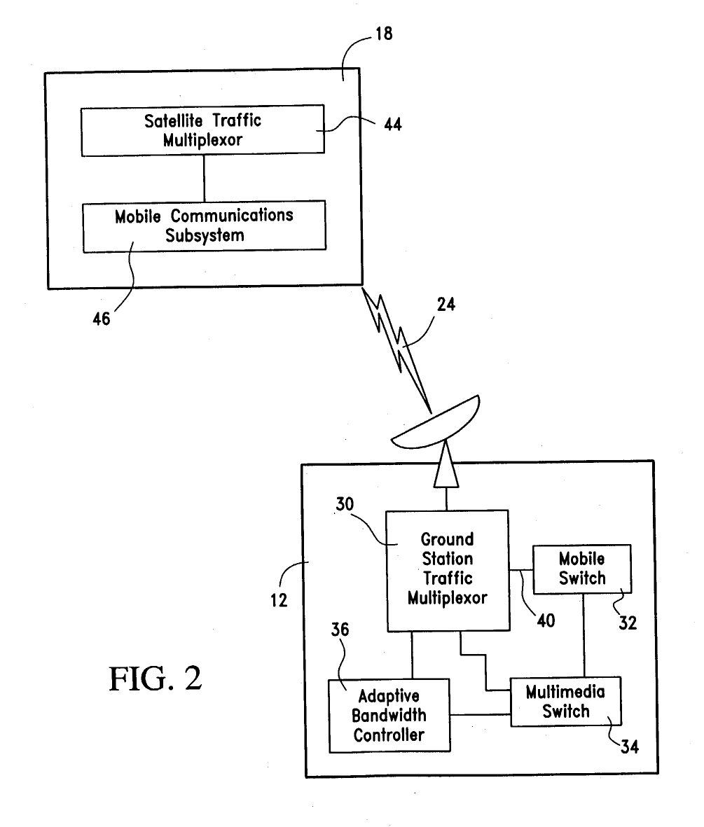

Referring now to FIG. 2, a more detailed view of a portion of mobile communications system 10 (FIG. 1) is shown according to an embodiment of the invention. First satellite 18, in this embodiment, comprises a satellite traffic multiplexor 44 and a mobile communications subsystem 46. These components perform functions similar to their counterparts within at least first ground station 12 and second ground station 14. Satellite traffic multiplexor 44 is coupled to ground station traffic multiplexor 30 of first ground station 12 via at least one user link taken from first set of user links 24. Mobile communications subsystem 46 is coupled to satellite traffic multiplexor 44. In at least one embodiment, each one of the set of satellites comprises the same or substantially similar equipment as first satellite 18, as described above.

Referring back to FIG. 1, adaptive bandwidth controller 36 is configured to perform the dynamic reallocation of the at least one user link. In one embodiment, this means that adaptive bandwidth controller 36 routes at least a portion of the backbone traffic between first ground station 12 and second ground station 14 across at least one of cross user links 29. Adaptive bandwidth controllers capable of performing this function are well known in the art and may be obtained from a variety of sources. Ground station traffic multiplexor 30, mobile switch 32, and multimedia switch 34 are also well known in the art and widely available, and existing router technologies are well adapted to perform the data routing contemplated in this description. Ground station traffic multiplexor 30, for example, is a communications device that combines several signals for transmission over a single medium. One function of ground station traffic multiplexor 30, then, is to combine several user traffic signals into a composite signal that becomes backbone traffic.

Referring still to FIG. 1, a two-way traffic link 40 is provided between ground station traffic multiplexor 30 and mobile switch 32. Two-way traffic link 40, along with all other status, control, and communication lines comprising mobile communications system 10, may comprise, in one embodiment, Telecom Management Network (TMN) or Simple Network Management Protocol (SNMP). A variety of platforms exist that operate over well-known protocols like SNMP over IP, for network management.

Two-way traffic link 40 facilitates the transfer of data, such as backbone traffic, between ground station traffic multiplexor 30 and mobile switch 32. Combined user traffic from first set of user terminals 22 enters first ground station 12 as separate signals that are then combined by ground station traffic multiplexor 30, after which the composite signal traverses two-way traffic link 40 toward mobile switch 32. When backbone link 16 is able to handle the entire backbone traffic load, multimedia switch 34, under direction from adaptive bandwidth controller 36, routes the combined traffic toward backbone link 16, which carries the combined traffic to its remote destination via another ground station, such as second ground station 14. More particularly, for backbone traffic traveling from first ground station 12 to second ground station 14, the path followed is from ground station traffic multiplexor 30 in first ground station 12, to mobile switch 32, to multimedia switch 34, across backbone link 16 to multimedia switch 34 in second ground station 14, to mobile switch 32, and then to ground station traffic multiplexor 30. From ground station traffic multiplexor 30 in second ground station 14, the backbone traffic is separated into its various individual user traffic signals and is subsequently sent to its various final destinations.

On the other hand, when backbone link 16 is unable to handle the entire backbone traffic load, multimedia switch 34, under direction from adaptive bandwidth controller 36, sends the backbone traffic back to ground station traffic multiplexor 30 from where it is sent along user links, such as at least one of user links 24, cross user links 29, and user links 28, that have been reallocated to accommodate the backbone traffic. Again focusing on backbone traffic traveling from first ground station 12 to second ground station 14, the path taken is as follows. Individual signals are combined in ground station traffic multiplexor 30 in first ground station 12 and routed to mobile switch 32 and from there to multimedia switch 34. Because backbone link 16 is compromised, the backbone traffic is then sent back to ground station traffic multiplexor 30, across at least one user link taken from first set of user links 24 to first satellite 18, and across at least one of cross user links 29 to second satellite 20. From there the backbone traffic traverses at least one user link taken from second set of user links 28 to arrive at ground station traffic multiplexor 30 in second ground station 14. It then passes to mobile switch 32 and on to multimedia switch 34, which sends it back to ground station traffic multiplexor 30 for separation and transmission to various final destinations.

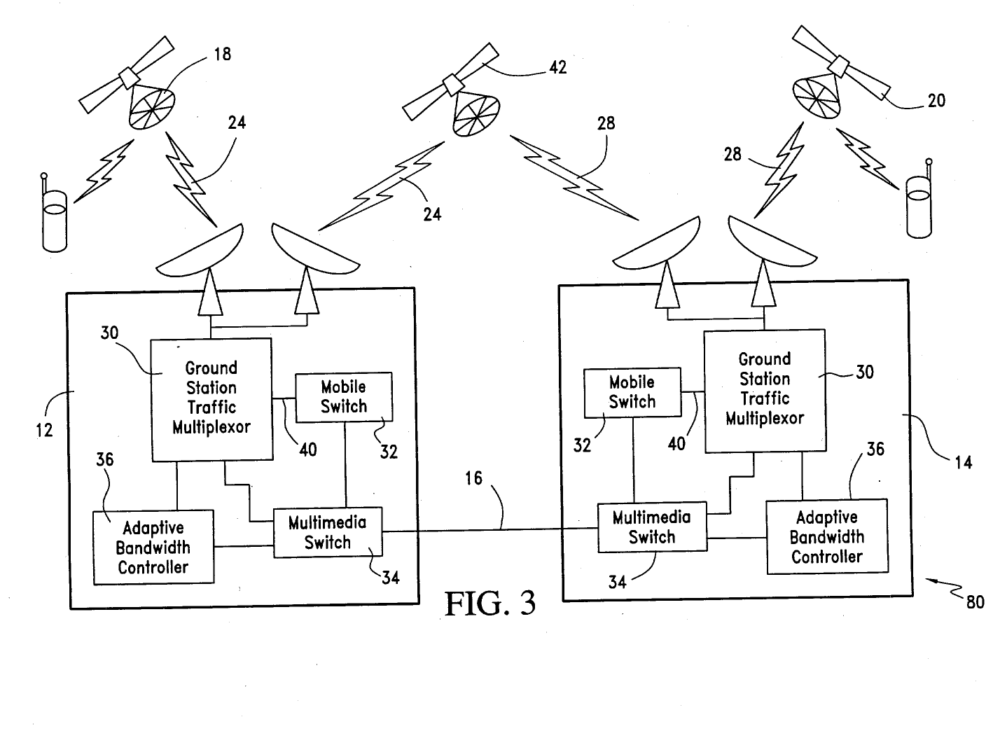

In an alternate embodiment, at least one of the ground stations comprising mobile communications system 10 is coupled to at least two of the set of satellites. In another or the same alternate embodiment, at least one of the satellites is coupled to at least two of the set of ground stations. These embodiments are illustrated in FIG. 3 as a mobile communications system 80, where first ground station 12 is coupled to first satellite 18 and to a third satellite 42 via first set of user links 24. Second ground station 14 is also coupled to third satellite 42, as well as to second satellite 20, via second set of user links 28. Similarly, third satellite 42 is coupled both to first ground station 12 and to second ground station 14 via portions of first set of user links 24 and second set of user links 28, as described. First satellite 18, second satellite 20, and third satellite 42 may or may not, in this embodiment, be connected with each other by cross user links (not shown in FIG. 3). In one embodiment, mobile switch 32, under direction from adaptive bandwidth controller 36, routes backbone traffic across backbone link 16 or across first set of user links 24 and second set of user links 28, as dictated by the capacity of backbone link 16 and as described hereinabove.

As has been mentioned hereinabove, backbone link 16 in either FIG. 1 or FIG. 3 may be connected to the PSTN or other hard wired or land-based communications networks. A signal destined for such a land-based network may follow a path like those described above, except that multimedia switch 34 would route any backbone traffic intended for a land-based network to that network across backbone link 16. When backbone link 16 is compromised, multimedia switch 34, in conjunction with adaptive bandwidth controller 36, may use a user link chosen from first set of user links 24, second set of user links 28, or cross user links 29 to bypass backbone link 16 as described. Signals destined for a land-based network may then navigate mobile communications system 10 until a backbone link 16 is found capable of carrying such signals to their final destination.

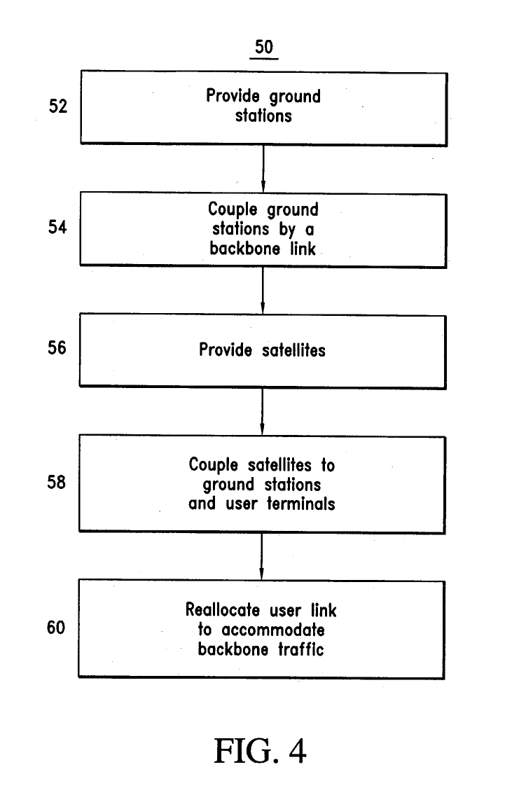

FIG. 4 illustrates a method 50 of routing data or operating a mobile communications system according to an embodiment of the present invention. A first step 52 of method 50 is to provide a set of ground stations, including at least a first ground station and a second ground station. A second step 54 of method 50 is to couple together the first ground station and the second ground station by using a backbone link configured to carry backbone traffic. It will be understood that if additional ground stations are present beyond the first and second ground stations that the additional ground stations are also coupled to the same or additional backbone links. In other words, a backbone link can be coupled to two or more ground stations. A third step 56 of method 50 is to provide a set of satellites, including at least a first satellite and a second satellite, and a fourth step 58 of method 50 is to couple the first satellite to the first ground station and to a first set of user terminals and to couple the second satellite to the second ground station and to a second set of user terminals. The coupling of the first satellite is accomplished by a first set of user links, and the coupling of the second satellite is accomplished by a second set of user links. The first set of user links and the second set of user links are configured to carry user traffic, as has been discussed hereinabove. A fifth step 60 of method 50 is to reallocate at least one of the user links to accommodate backbone traffic.

Fifth step 60 of method 50 may, in one embodiment, comprise a dynamic reallocation of at least one user link in response to changing conditions experienced by the mobile communications system. One such change in conditions may be a decrease in the ability of the backbone link to handle the full amount of backbone traffic waiting to be transported across it. The reallocation may be performed by an adaptive bandwidth controller comprising part of the mobile communications system.

Although the invention has been described with reference to specific embodiments, it will be understood by those skilled in the art that various changes may be made therein without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

All elements claimed in the claims are considered essential to the invention, and replacement of one or more claimed elements constitutes reconstruction and not repair of the claimed invention. Moreover, embodiments and limitations disclosed herein are not dedicated to the public under the doctrine of dedication if the embodiments and/or limitations: (1) are not expressly claimed in the claims and (2) are or are potentially equivalents of express elements and/or limitations in the claims under the doctrine of equivalents.

What is claimed is:

1. A mobile communications system for use with a first set of user terminals and a second set of user terminals, the mobile communications system comprising:
a set of ground stations, including at least a first ground station and a second ground station coupled by a backbone link configured to carry backbone traffic; and
a set of satellites including at least a first satellite coupled to the first ground station and to the first set of user terminals by a first set of user links, and a second satellite coupled to the second ground station and to the second set of user terminals by a second set of user links, the first set of user links and the second set of user links configured to carry user traffic,
wherein:
each one of the set of ground stations is configured to at least temporarily reallocate at least one user link taken from either the first set of user links or the second set of user links to accommodate the backbone traffic.

2. The mobile communications system of claim 1 wherein each of the set of ground stations is configured to dynamically reallocate at least one user link taken from either the first set of user links or the second set of user links in response to changing conditions experienced by the mobile communications system.

3. The mobile communications system of claim 2 wherein:
each one of the set of ground stations comprises:
a ground station traffic multiplexor;
a mobile switch coupled to the ground station traffic multiplexor;
a multimedia switch coupled to the mobile switch and the ground station traffic multiplexor; and
an adaptive bandwidth controller coupled to the multimedia switch and the ground station traffic multiplexor.

4. The mobile communications system of claim 3 wherein the multimedia switch of the first ground station is coupled to the multimedia switch of the second ground station.

5. The mobile communications system of claim 3 wherein each of the adaptive bandwidth controllers control the dynamic reallocation of at least one user link taken from either the first set of user links or the second set of user links.

6. The mobile communications system of claim 5 wherein:
each of the adaptive bandwidth controllers controls the dynamic reallocation in response to changing conditions experienced by the mobile communications system; and
the changing conditions experienced by the mobile communications system includes a change in capacity of the backbone link.

7. The mobile communications system of claim 3 wherein each one of the set of satellites comprises:
a satellite traffic multiplexor coupled to at least one ground station traffic multiplexor; and
a mobile communications subsystem coupled to at least one ground station traffic multiplexor.

8. The mobile communications system of claim 3 wherein each of the adaptive bandwidth controllers is configured to control routing of at least a portion of the backbone traffic between two of the set of ground stations across the at least one user link taken from either the first set of user links or the second set of user links.

9. The mobile communications system of claim 3 wherein a two-way traffic link is provided within each one of the set of ground stations between the ground station traffic multiplexor and the mobile switch.

10. The mobile communications system of claim 1 wherein at least one of the ground stations is coupled to at least two of the set of satellites.

11. The mobile communications system of claim 1 wherein at least one of the set of satellites is coupled to at least two of the set of ground stations.

12. The mobile communications system of claim 1 wherein the first set of user links and the second set of user links comprise a portion of a radio frequency spectrum.

13. A mobile communications system comprising:
a first ground station and a second ground station;
a first user link coupling a first user terminal to the first ground station, and a second user link coupling a second user terminal to the second ground station; and
a backbone link configured to carry backbone traffic coupling the first ground station and the second ground station, wherein the first ground station and the second ground station are configured to at least temporarily direct the backbone traffic along the first user link and the second user link.

14. The mobile communications system of claim 13 wherein the first user link and the second user link comprise a portion of a radio frequency spectrum.

15. The mobile communications system of claim 13 further comprising:
a first satellite coupled to the first user terminal and the first ground station by the first user link; and
a second satellite coupled to the second user terminal and the second ground station by the second user link.

16. The mobile communications system of claim 13 wherein:
at least one of the first ground station and the second ground station further comprises an adaptive bandwidth controller, the adaptive bandwidth controller directing the backbone traffic along the first user link and the second user link.

17. The mobile communications system of claim 16 wherein the adaptive bandwidth controller controls a dynamic redirection of backbone traffic along the first user link and the second user link in response to a reduction in capacity of the backbone link.

18. A method of operating a mobile communications system for use with a first set of user terminals and a second set of user terminals, the method comprising the steps of:
providing a set of ground stations, including at least a first ground station and a second ground station;
coupling the first ground station and the second ground station by a background link configured to carry backbone traffic;
providing a set of satellites, including at least a first satellite and a second satellite;
coupling the first satellite to the first ground station and to a first set of user terminals by a first set of user links configured to carry user traffic;
coupling the second satellite to the second ground station and to a second set of user terminals by a second set of user links configured to carry the user traffic; and
at least temporarily reallocating at least one user link taken from either the first set of user links or the second set of user links to accommodate the backbone traffic.

19. The method of claim 18 wherein at least temporarily reallocating at least one user link taken from either the first set of user links or the second set of user links to accommodate the backbone traffic comprises dynamically reallocating the at least one user link taken from either the first set of user links or the second set of user links in response to changing conditions experienced by the mobile communications system.

20. The method of claim 19 wherein dynamically reallocating the at least one user link taken from either the first set of user links or the second set of user links is controlled by at least one adaptive bandwidth controller in at least one of the set of ground stations.
